(19) United States
(12) Patent Application Publication
(10) Pub. No.: US 2019/0219019 A1
(43) Pub. Date: Jul. 18, 2019

(54) METHODS AND SYSTEM FOR OPERATING AN ENGINE

(71) Applicant: Ford Global Technologies, LLC, Dearborn, MI (US)

(72) Inventors: Hafiz Khafagy, Dearborn, MI (US); Gary Paisley, Romford (GB); David Hesketh, Ingatestone (GB); Jonathan Wentworth, Chelmsford (GB); Dilli Raj Poudel, Chigwell (GB)

(21) Appl. No.: 15/873,733

(22) Filed: Jan. 17, 2018

(51) Int. Cl. F02N 11/08; F02D 41/04; B60W 10/06; B60W 10/08; B60W 20/40; B60W 30/18

(52) U.S. Cl. CPC F02N 11/0829; B60W 2510/18; F02D 41/042; B60W 10/06; B60W 10/08; B60W 20/40; B60W 30/18018; F02N 2200/101; F02N 2200/102; F02N 2200/103; F02N 2200/0801; F02N 2200/061; B60W 2510/244; B60W 2510/0233; B60W 2520/28; B60W 2520/04; B60W 2510/0657; F02N 11/0822

(57) ABSTRACT

Systems and methods for operating an engine of a vehicle that may be automatically stopped and started are disclosed. In one example, a speed at which a vehicle system induced automatic engine stop inhibit request is cleared may be adjusted to permit automatic engine stopping during a wide variety of driving conditions so that fuel may be conserved and the possibility of disturbing vehicle occupants may be reduced.

### FIELD

The present description relates to methods and a system for operating an engine that may be automatically stopped and started to conserve fuel. The methods and systems may be particularly useful for vehicles that are driven under a wide variety of operating conditions.

### BACKGROUND AND SUMMARY

An engine may be automatically stopped without vehicle occupants specifically requesting an engine stop via a dedicated engine start and stop input device, such as an ignition switch or pushbutton, to conserve fuel. The engine may also be automatically restarted in response to driver inputs or system operating conditions. For example, the engine may be automatically restarted in response to an increasing driver demand torque. The engine may also be restarted in response to a system condition, such as battery state of charge, even when there is a very low driver demand torque. If the engine is started in response to system conditions, it may not be allowed to automatically stop again until a specific condition is met to ensure that the engine is not repeatedly stopped and restarted within a short period of time. However, the specific condition may not be met for a long period of time so that opportunities for stopping the engine and conserving fuel may be lost.

The inventors herein have recognized the above-mentioned issues and have developed an engine operating method, comprising: automatically stopping an engine; automatically starting the engine after automatically stopping the engine in response to a vehicle system induced automatic engine stop inhibit request; and adjusting a vehicle speed at which the vehicle system induced automatic engine stop inhibit request is cancelled responsive to a lowest vehicle speed achieved while the engine was automatically stopped.

By adjusting a vehicle speed at which a vehicle system induced automatic engine stop inhibit request is cancelled, it may be possible to provide the technical result of allowing automatic engine stops while reducing a possibility of frequent engine stops and starts where there is only a small amount of time between the engine stop and the engine restart. In one example, a vehicle speed at which the vehicle system induced automatic engine stop inhibit request is cancelled may be adjusted based on a lowest vehicle speed achieved while the engine was automatically stopped. By adjusting a vehicle speed at which the vehicle system induced automatic engine stop inhibit request is cancelled based on the lowest vehicle speed achieved while the engine was automatically stopped, the vehicle system induced automatic engine stop inhibit request may be cancelled in a way that changes with vehicle operating conditions so that it may be possible to continue to automatically stop the engine even when vehicle operating conditions are changing. Consequently, it may be possible to restart the engine in response to system conditions while still retaining the ability to stop the engine to conserve fuel.

The present description may provide several advantages. In particular, the approach may provide for reduced engine fuel consumption while permitting engine restarting responsive to system conditions. Further, the approach provides for adaptive automatic engine stopping enablement so that vehicle occupants may find automatic engine stopping and starting less objectionable. Further still, the approach may be applied to hybrid vehicles and non-hybrid vehicles.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of an engine.

FIGS. 2A and 2B are schematic diagrams of two example vehicle drivelines.

FIG. 3 shows an example engine operating sequence for the system of FIGS. 1-2B.

FIG. 4 shows a flowchart of an example method for operating an engine.

### DETAILED DESCRIPTION

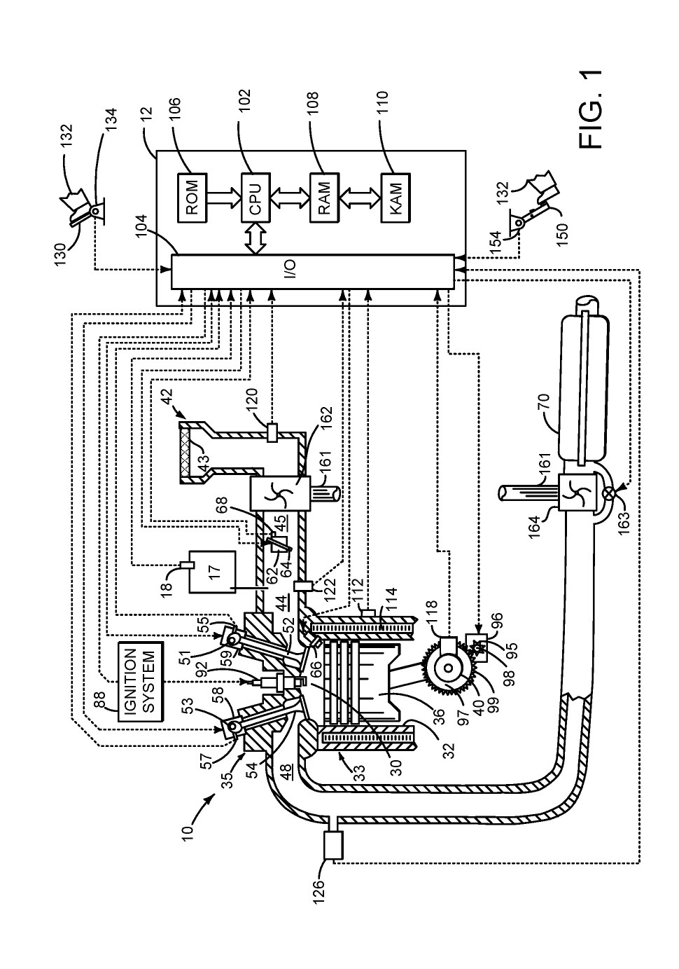

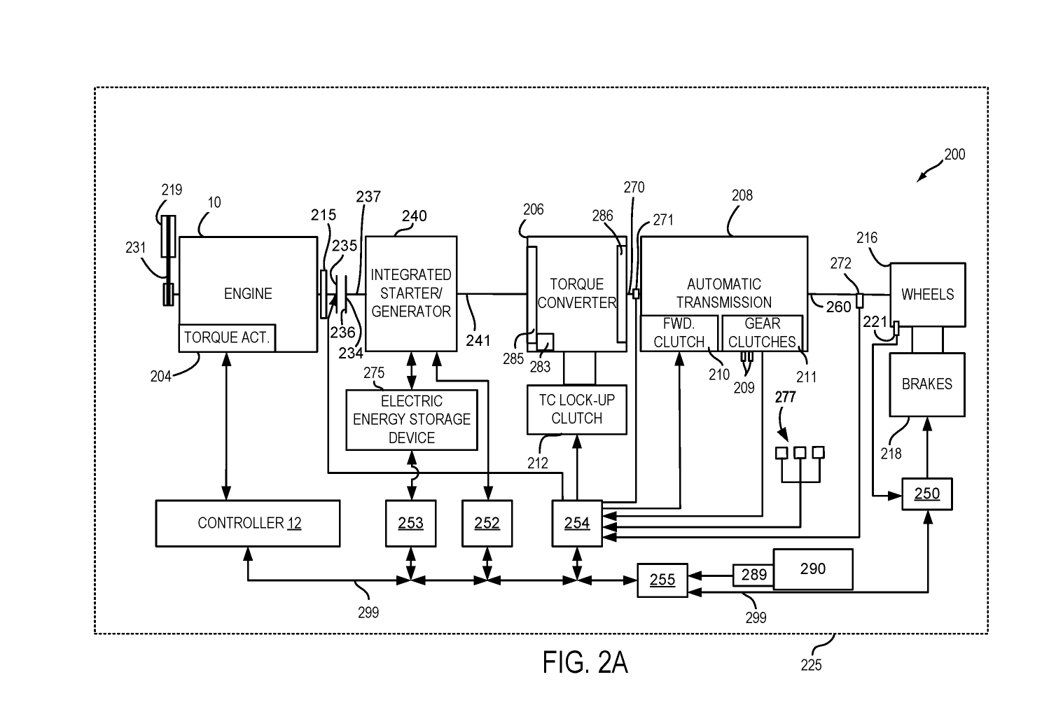

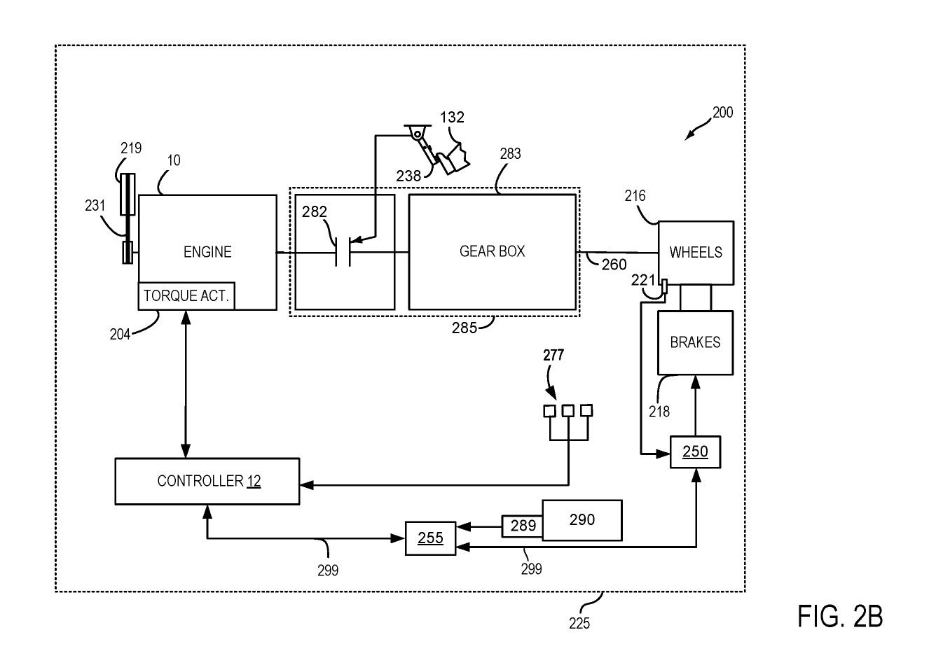

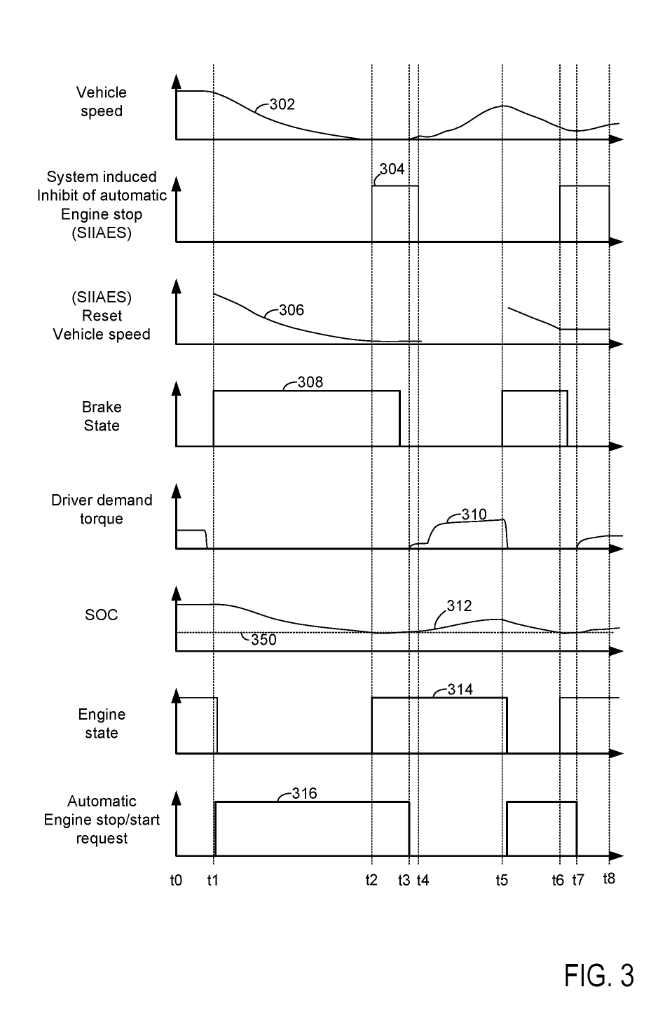

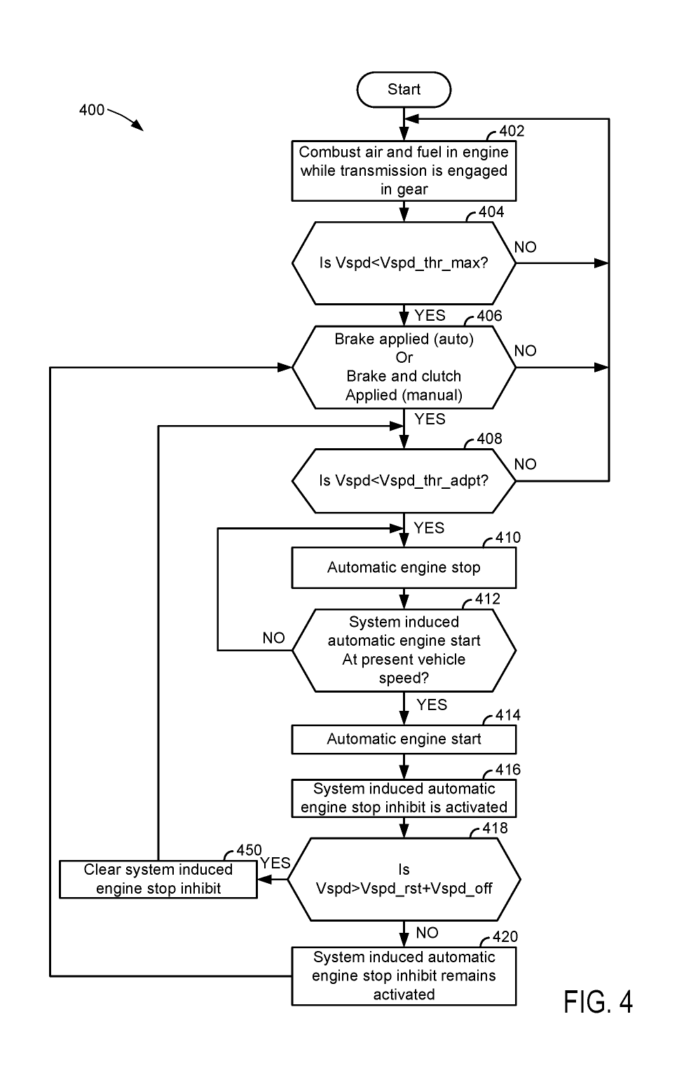

The present description is related to operating an engine of a stop/start vehicle. The stop/start vehicle may automatically stop the engine only when the vehicle is at rest, or alternatively, the stop/start vehicle may stop the engine while the vehicle is moving. An example engine is shown in FIG. 1. The internal combustion engine may be included in a driveline or powertrain of a hybrid vehicle as shown in FIGS. 2A and 2B. The engine may be operated as is shown in the sequence of FIG. 3 according to the method of FIG. 4.

Referring to FIG. 1, internal combustion engine 10, comprising a plurality of cylinders, one cylinder of which is shown in FIG. 1, is controlled by electronic engine controller 12. The controller 12 receives signals from the various sensors shown in FIG. 1 and employs the various actuators of FIG. 1 to adjust engine operation based on received signals and executable instructions stored in controller memory.

Engine 10 is comprised of cylinder head 35 and block 33, which include combustion chamber 30 and cylinder walls 32. Piston 36 is positioned therein and reciprocates via a connection to crankshaft 40. Flywheel 97 and ring gear 99 are coupled to crankshaft 40. Optional starter 96 (e.g., low voltage (operated with less than 30 volts) electric machine) includes pinion shaft 98 and pinion gear 95. Pinion shaft 98 may selectively advance pinion gear 95 to engage ring gear 99. Starter 96 may be directly mounted to the front of the engine or the rear of the engine. In some examples, starter 96 may selectively supply torque to crankshaft 40 via a belt or chain. In one example, starter 96 is in a base state when not engaged to the engine crankshaft.

Combustion chamber 30 is shown communicating with intake manifold 44 and exhaust manifold 48 via respective intake poppet valve 52 and exhaust poppet valve 54. Each intake and exhaust valve may be operated by an intake camshaft 51 and an exhaust camshaft 53. The position of intake camshaft 51 may be determined by intake camshaft sensor 55. The position of exhaust camshaft 53 may be determined by exhaust camshaft sensor 57. Intake valves may be held open or closed over an entire engine cycle as the engine rotates via deactivating intake valve actuator 59, which may electrically, hydraulically, or mechanically operate intake valves. Alternatively, intake valves may be opened and closed during a cycle of the engine. Exhaust valves may be held open or closed over an entire engine cycle (e.g., two engine revolutions) as the engine rotates via deactivating exhaust valve actuator 58, which may be electrically, hydraulically, or mechanically operate exhaust valves. Alternatively, exhaust valves may be opened and closed during a cycle of the engine.

Fuel injector 66 is shown positioned to inject fuel directly into cylinder 30, which is known to those skilled in the art as direct injection. Fuel injector 66 delivers liquid fuel in proportion to the pulse width from controller 12. Fuel is delivered to fuel injector 66 by a fuel system (not shown) including a fuel tank, fuel pump, and fuel rail (not shown). In one example, a high pressure, dual stage, fuel system may be used to generate higher fuel pressures.

In addition, intake manifold 44 is shown communicating with turbocharger compressor 162 and engine air intake 42. In other examples, compressor 162 may be a supercharger compressor. Shaft 161 mechanically couples turbocharger turbine 164 to turbocharger compressor 162. Optional electronic throttle 62 adjusts a position of throttle plate 64 to control air flow from compressor 162 to intake manifold 44. Pressure in boost chamber 45 may be referred to a throttle inlet pressure since the inlet of throttle 62 is within boost chamber 45. The throttle outlet is in intake manifold 44. In some examples, throttle 62 and throttle plate 64 may be positioned between intake valve 52 and intake manifold 44 such that throttle 62 is a port throttle. Wastegate 163 may be adjusted via controller 12 to allow exhaust gases to selectively bypass turbine 164 to control the speed of compressor 162. Air filter 43 cleans air entering engine air intake 42.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Converter 70 can include multiple catalyst bricks, in one example. In another example, multiple emission control devices, each with multiple bricks, can be used. Converter 70 can be a three-way type catalyst in one example.

Engine 10 may supply vacuum to vacuum reservoir 17 via intake manifold 44 to power vacuum consumers such as vehicle brakes and climate control system 289 shown in FIGS. 2A and 2B. The amount of vacuum may be determined via vacuum sensor 18. Engine 10 may be activated after it has been automatically stopped to increase an amount of vacuum stored in vacuum reservoir 17.

Controller 12 is shown in FIG. 1 as a conventional microcomputer including: microprocessor unit 102, input/output ports 104, read-only memory 106 (e.g., non-transitory memory), random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an accelerator pedal 130 for sensing force applied by human driver 132; a position sensor 154 coupled to brake pedal 150 for sensing force applied by human driver 132, a measurement of engine manifold pressure (MAP) from pressure sensor 122 coupled to intake manifold 44; an engine position sensor from a Hall effect sensor 118 sensing crankshaft 40 position; a measurement of air mass entering the engine from sensor 120; and a measurement of throttle position from sensor 68. Barometric pressure may also be sensed (sensor not shown) for processing by controller 12. In a preferred aspect of the present description, engine position sensor 118 produces a predetermined number of equally spaced pulses every revolution of the crankshaft from which engine speed (RPM) can be determined.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC).

During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion.

During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

Engine torque may be adjusted via torque actuators including fuel injector 66, ignition system 88, throttle 62, intake valve operator 59 and exhaust valve operator 58, and wastegate 163. Engine torque may be adjusted responsive to vehicle operating conditions.

FIG. 2A is a block diagram of a vehicle 225 including a powertrain or driveline 200. The powertrain of FIG. 2A includes engine 10 shown in FIG. 1. Powertrain 200 is shown including vehicle system controller 255, engine controller 12, electric machine controller 252, transmission controller 254, energy storage device controller 253, and brake controller 250. Vehicle system controller 255 may also communicate with passenger cabin climate control system 289. Climate control system 289 may heat or cool passenger cabin 290. The controllers may communicate over controller area network (CAN) 299. Each of the controllers may provide information to other controllers such as torque output limits (e.g., torque output of the device or component being controlled not to be exceeded), torque input limits (e.g., torque input of the device or component being controlled not to be exceeded), torque output of the device being controlled, sensor and actuator data, diagnostic information (e.g., information regarding a degraded transmission, information regarding a degraded engine, information regarding a degraded electric machine, information regarding degraded brakes). Further, the vehicle system controller 255 may provide commands to engine controller 12, electric machine controller 252, transmission controller 254, and brake controller 250 to achieve driver input requests and other requests that are based on vehicle operating conditions.

For example, in response to a driver releasing an accelerator pedal and vehicle speed, vehicle system controller 255 may request a desired wheel torque or a wheel power level to provide a desired rate of vehicle deceleration. The desired wheel torque may be provided by vehicle system controller 255 requesting a first braking torque from electric machine controller 252 and a second braking torque from brake controller 250, the first and second torques providing the desired braking torque at vehicle wheels 216.

In other examples, the partitioning of controlling powertrain devices may be partitioned differently than is shown in FIG. 2A. For example, a single controller may take the place of vehicle system controller 255, engine controller 12, electric machine controller 252, transmission controller 254, and brake controller 250. Alternatively, the vehicle system controller 255 and the engine controller 12 may be a single unit while the electric machine controller 252, the transmission controller 254, and the brake controller 250 are standalone controllers.

In this example, powertrain 200 may be powered by engine 10 and electric machine 240. Engine 10 may be started with an engine starting system shown in FIG. 1, via belt driven integrated starter/generator (BISG) 219, or via driveline integrated starter/generator (ISG) 240 also known as a motor/generator. Driveline ISG 240 (e.g., high voltage (operated with greater than 30 volts) electrical machine) may also be referred to as an electric machine, motor, and/or generator. Further, torque of engine 10 may be adjusted via torque actuator 204, such as a fuel injector, throttle, etc.

BISG 219 is mechanically coupled to engine 10 via belt 231. BISG 219 may be coupled to crankshaft 40 or a camshaft (e.g., 51 or 53). BISG 219 may operate as a motor when supplied with electrical power via electric energy storage device 275. BISG 219 may operate as a generator supplying electrical power to electric energy storage device 275.

An engine output torque may be transmitted to an input or first side of powertrain disconnect clutch 235 through dual mass flywheel 215. Disconnect clutch 236 may be electrically or hydraulically actuated. The downstream or second side 234 of disconnect clutch 236 is shown mechanically coupled to ISG input shaft 237.

ISG 240 may be operated to provide torque to powertrain 200 or to convert powertrain torque into electrical energy to be stored in electric energy storage device 275 in a regeneration mode. ISG 240 is in electrical communication with energy storage device 275. ISG 240 has a higher output torque capacity than starter 96 shown in FIG. 1 or BISG 219. Further, ISG 240 directly drives powertrain 200 or is directly driven by powertrain 200. There are no belts, gears, or chains to couple ISG 240 to powertrain 200. Rather, ISG 240 rotates at the same rate as powertrain 200. Electrical energy storage device 275 (e.g., high voltage battery or power source) may be a battery, capacitor, or inductor. The downstream side of ISG 240 is mechanically coupled to the impeller 285 of torque converter 206 via shaft 241. The upstream side of the ISG 240 is mechanically coupled to the disconnect clutch 235. ISG 240 may provide a positive torque or a negative torque to powertrain 200 via operating as a motor or generator as instructed by electric machine controller 252.

Torque converter 206 includes a turbine 286 to output torque to input shaft 270. Transmission input shaft 270 mechanically couples torque converter 206 to automatic transmission 208. Torque converter 206 also includes a torque converter bypass lock-up clutch 212 (TCC). Torque is directly transferred from impeller 285 to turbine 286 when TCC is locked. TCC is electrically operated by controller 254. Alternatively, TCC may be hydraulically locked. In one example, the torque converter may be referred to as a component of the transmission.

When torque converter lock-up clutch 212 is fully disengaged, torque converter 206 transmits engine torque to automatic transmission 208 via fluid transfer between the torque converter turbine 286 and torque converter impeller 285, thereby enabling torque multiplication. In contrast, when torque converter lock-up clutch 212 is fully engaged, the engine output torque is directly transferred via the torque converter clutch to an input shaft 270 of transmission 208. Alternatively, the torque converter lock-up clutch 212 may be partially engaged, thereby enabling the amount of torque directly relayed to the transmission to be adjusted. The transmission controller 254 may be configured to adjust the amount of torque transmitted by torque converter 212 by adjusting the torque converter lock-up clutch in response to various engine operating conditions, or based on a driver-based engine operation request.

Torque converter 206 also includes pump 283 that pressurizes fluid to operate disconnect clutch 236, forward clutch 210, and gear clutches 211. Pump 283 is driven via impeller 285, which rotates at a same speed as ISG 240.

Automatic transmission 208 includes gear clutches (e.g., gears 1-10) 211 and forward clutch 210. Automatic transmission 208 is a fixed step ratio transmission. The gear clutches 211 and the forward clutch 210 may be selectively engaged to change a ratio of an actual total number of turns of input shaft 270 to an actual total number of turns of wheels 216. Gear clutches 211 may be engaged or disengaged via adjusting fluid supplied to the clutches via shift control solenoid valves 209. Torque output from the automatic transmission 208 may also be relayed to wheels 216 to propel the vehicle via output shaft 260. Specifically, automatic transmission 208 may transfer an input driving torque at the input shaft 270 responsive to a vehicle traveling condition before transmitting an output driving torque to the wheels 216. Transmission controller 254 selectively activates or engages TCC 212, gear clutches 211, and forward clutch 210. Transmission controller also selectively deactivates or disengages TCC 212, gear clutches 211, and forward clutch 210.

Further, a frictional force may be applied to wheels 216 by engaging friction wheel brakes 218. In one example, friction wheel brakes 218 may be engaged in response to the driver pressing his/her foot on a brake pedal (not shown) and/or in response to instructions within brake controller 250. Further, brake controller 250 may apply brakes 218 in response to information and/or requests made by vehicle system controller 255. In the same way, a frictional force may be reduced to wheels 216 by disengaging wheel brakes 218 in response to the driver releasing his foot from a brake pedal, brake controller instructions, and/or vehicle system controller instructions and/or information. For example, vehicle brakes may apply a frictional force to wheels 216 via controller 250 as part of an automated engine stopping procedure.

In response to a request to accelerate vehicle 225, vehicle system controller may obtain a driver demand torque or power request from an accelerator pedal or other device. Vehicle system controller 255 then allocates a fraction of the requested driver demand torque to the engine and the remaining fraction to the ISG 240 or BISG 219. Vehicle system controller 255 requests the engine torque from engine controller 12 and the ISG torque from electric machine controller 252. If the ISG torque plus the engine torque is less than a transmission input torque limit (e.g., a threshold value not to be exceeded), the torque is delivered to torque converter 206, which then relays at least a fraction of the requested torque to transmission input shaft 270. Transmission controller 254 selectively locks torque converter clutch 212 and engages gears via gear clutches 211 in response to shift schedules and TCC lockup schedules that may be based on input shaft torque and vehicle speed. In some conditions when it may be desired to charge electric energy storage device 275, a charging torque (e.g., a negative ISG torque) may be requested while a non-zero driver demand torque is present. Vehicle system controller 255 may request increased engine torque to overcome the charging torque to meet the driver demand torque.

In response to a request to decelerate vehicle 225 and provide regenerative braking, vehicle system controller may provide a negative desired wheel torque based on vehicle speed and brake pedal position. Vehicle system controller 255 then allocates a fraction of the negative desired wheel torque to the ISG 240 (e.g., desired powertrain wheel torque) and/or engine 10, and the remaining fraction to friction brakes 218 (e.g., desired friction brake wheel torque). Further, vehicle system controller may notify transmission controller 254 that the vehicle is in regenerative braking mode so that transmission controller 254 shifts gears 211 based on a unique shifting schedule to increase regeneration efficiency. ISG 240 supplies a negative torque to transmission input shaft 270, but negative torque provided by ISG 240 may be limited by transmission controller 254 which outputs a transmission input shaft negative torque limit (e.g., not to be exceeded threshold value). Further, negative torque of ISG 240 may be limited (e.g., constrained to less than a threshold negative threshold torque) based on operating conditions of electric energy storage device 275, by vehicle system controller 255, or electric machine controller 252. Engine 10 may also provide a negative torque by ceasing fuel delivery to engine cylinders. Engine cylinders may be deactivated with intake and exhaust valves opening and closing during engine rotation or with intake and exhaust valves held closed over one or more engine cycles while the engine rotates. Any portion of desired negative wheel torque that may not be provided by engine 10 and/or ISG 240 because of transmission or ISG limits may be allocated to friction brakes 218 so that the desired wheel torque is provided by a combination of negative wheel torque from friction brakes 218 and ISG 240.

Accordingly, torque control of the various powertrain components may be supervised by vehicle system controller 255 with local torque control for the engine 10, transmission 208, electric machine 240, and brakes 218 provided via engine controller 12, electric machine controller 252, transmission controller 254, and brake controller 250.

As one example, an engine torque output may be controlled by adjusting a combination of spark timing, fuel pulse width, fuel pulse timing, and/or air charge, by controlling throttle opening and/or valve timing, valve lift and boost for turbo- or super-charged engines. In the case of a diesel engine, controller 12 may control the engine torque output by controlling a combination of fuel pulse width, fuel pulse timing, and air charge. In all cases, engine control may be performed on a cylinder-by-cylinder basis to control the engine torque output.

Electric machine controller 252 may control torque output and electrical energy production from ISG 240 by adjusting current flowing to and from field and/or armature windings of ISG as is known in the art.

Transmission controller 254 receives transmission input shaft position via position sensor 271. Transmission controller 254 may convert transmission input shaft position into input shaft speed via differentiating a signal from position sensor 271 or counting a number of known angular distance pulses over a predetermined time interval. Transmission controller 254 may receive transmission output shaft torque from torque sensor 272. Alternatively, sensor 272 may be a position sensor or torque and position sensors. If sensor 272 is a position sensor, controller 254 may count shaft position pulses over a predetermined time interval to determine transmission output shaft velocity. Transmission controller 254 may also differentiate transmission output shaft velocity to determine transmission output shaft acceleration. Transmission controller 254, engine controller 12, and vehicle system controller 255, may also receive addition transmission information from sensors 277, which may include but are not limited to pump output line pressure sensors, transmission hydraulic pressure sensors (e.g., gear clutch fluid pressure sensors), ISG temperature sensors, and BISG temperatures, and ambient temperature sensors.

Brake controller 250 receives wheel speed information via wheel speed sensor 221 and braking requests from vehicle system controller 255. Brake controller 250 may also receive brake pedal position information from brake pedal sensor 154 shown in FIG. 1 directly or over CAN 299. Brake controller 250 may provide braking responsive to a wheel torque command from vehicle system controller 255. Brake controller 250 may also provide anti-skid and vehicle stability braking to improve vehicle braking and stability. As such, brake controller 250 may provide a wheel torque limit (e.g., a threshold negative wheel torque not to be exceeded) to the vehicle system controller 255 so that negative ISG torque does not cause the wheel torque limit to be exceeded. For example, if controller 250 issues a negative wheel torque limit of 50 N-m, ISG torque is adjusted to provide less than 50 N-m (e.g., 49 N-m) of negative torque at the wheels, including accounting for transmission gearing.

Referring now to FIG. 2B, an alternative driveline or powertrain 200 is shown. The driveline of FIG. 2B includes many of the same components as shown in FIG. 2A. Components in FIG. 2B having the same numerical values as components shown in FIG. 2A are the same components. Further, same components operate in a same way. Therefore, for the sake of brevity, descriptions of similar components may be omitted.

Driveline 200 includes engine 10 which is mechanically coupled to manual transmission 285. Manual transmission 285 includes manual clutch 282 and gearbox 283. Manual clutch 282 may be opened or closed via manual clutch pedal 238. Human driver 132 may open manual clutch 282 via depressing manual clutch pedal 238 or close manual clutch 282 via releasing manual clutch pedal 238. Engine torque may be transmitted to manual gearbox 283 when manual clutch 282 is closed. Manual gearbox may transmit engine torque to wheels 216 via output shaft 260.

Thus, the system of FIGS. 1-2B provide for a system, comprising: an engine; and a controller including executable instructions stored in non-transitory memory to automatically stop the engine, monitor vehicle speed while the engine is automatically stopped, automatically restart the engine in response to a vehicle system induced automatic engine stop inhibit request, and clear the vehicle system induced automatic engine stop inhibit request in response to a lowest vehicle speed achieved while the engine was automatically stopped. The system includes where the lowest vehicle speed is a speed of a vehicle that the engine propels. The system further comprises additional instructions to assert the vehicle system induced automatic engine stop inhibit request in response to a battery state of charge. The system further comprises additional instructions to assert the vehicle system induced automatic engine stop inhibit request in response to a vacuum level. The system further comprises additional instructions to assert the vehicle system induced automatic engine stop inhibit request in response to a vehicle climate control system.

Referring now to FIG. 3, an example engine operating sequence is shown. The sequence of FIG. 3 may be provided according to the method of FIG. 4 along with or in conjunction with the system of FIGS. 1-2B. The plots shown in FIG. 3 occur at the same time and are aligned in time. The vertical lines at times t1-t8 represent times of interest during the engine operating sequence.

The first plot from the top of FIG. 3 is a plot of vehicle speed versus time. The vertical axis represents vehicle speed and vehicle speed increases in the direction of the vertical axis arrow. The horizontal axis represents time and time increases from the left side of the figure to the right side of the figure. Trace 302 represents vehicle speed.

The second plot from the top of FIG. 3 is a plot of system induced inhibit of automatic engine stop/start state versus time. The vertical axis represents system induced inhibit of automatic engine stop/start state and system induced inhibit of automatic engine stop/start state is asserted or activated when trace 304 is at a higher level near the vertical axis arrow. System induced inhibit of automatic engine stop/start state is not asserted when trace 304 is at a lower level near the horizontal axis. The horizontal axis represents time and time increases from the left side of the figure to the right side of the figure. Trace 304 represents system induced inhibit of automatic engine stop/start state.

System induced inhibit of automatic engine stop/start is a controller generated inhibit of automatic engine stop/start. Automatic engine stop/start allows an engine to be automatically stopped and started in response to vehicle conditions without a human driver providing input to a device that has a sole dedicated function of requesting engine starting or stopping (e.g., an ignition switch or an ignition pushbutton). If automatic engine stop/start is activated responsive to vehicle operating conditions (e.g., low driver demand torque and high battery state of charge), a system induced inhibit of automatic engine stop/start prevents the engine from automatically stopping. If the engine is already stopped due to automatic engine stop/start, the engine is automatically started when the system induced inhibit of automatic engine stop/start is asserted. Thus, the system induced inhibit of automatic engine stop/start may override automatic engine stop/start. A system induced inhibit of automatic engine stop/start may be generated in response to a variety of vehicle operating conditions including but not limited to low state of battery charge, low battery voltage, a climate control request to improve passenger cabin heating or cooling, battery current greater than a threshold current, low vacuum level in a vacuum reservoir, vehicle stopped on a grade that is greater than a threshold, steering angle greater than a threshold, and rate of steering angle change greater than a threshold.

The third plot from the top of FIG. 3 is a plot of system induced inhibit of automatic engine stop/start reset vehicle speed versus time. The vertical axis represents system induced inhibit of automatic engine stop/start reset vehicle speed and system induced inhibit of automatic engine stop/start reset vehicle speed increases in the direction of the vertical axis arrow. The horizontal axis represents time and time increases from the left side of the figure to the right side of the figure. Trace 306 represents system induced inhibit of automatic engine stop/start reset vehicle speed.

The system induced inhibit of automatic engine stop/start reset vehicle speed is a vehicle speed above which the system induced inhibit of automatic engine stop/start may be reset or not asserted once the system induced inhibit of automatic engine stop/start has been asserted. For example, if system induced inhibit of automatic engine stop/start is asserted and the system induced inhibit of automatic engine stop/start reset vehicle speed is 30 Kilometers per hour, the system induced inhibit of automatic engine stop/start may be reset or deactivated when vehicle speed achieves 30 Kilometers per hour.

The fourth plot from the top of FIG. 3 is a plot of vehicle brake state versus time. The vertical axis represents the vehicle brake state and the vehicle brake is applied when trace 308 is at a higher level near the vertical axis arrow. The vehicle brake is not applied when trace 308 is at a lower level near the horizontal axis. The horizontal axis represents time and time increases from the right side of the plot to the left side of the plot. Trace 308 represents vehicle brake state.

The fifth plot from the top of FIG. 3 is a plot of driver demand torque versus time. The vertical axis represents driver demand torque and driver demand torque increases in the direction of the vertical axis arrow. The horizontal axis represents time and time increases from the left side of the figure to the right side of the figure. Trace 310 represents driver demand torque.

The sixth plot from the top of FIG. 3 is a plot of battery state of charge (SOC) versus time. The vertical axis represents battery SOC and SOC increases in the direction of the vertical axis arrow. The SOC is zero at the horizontal axis. The horizontal axis represents time and time increases from the left side of the figure to the right side of the figure. Trace 312 represents battery SOC. Horizontal line 350 represents a threshold SOC below which automatic engine stopping is not desired.

The seventh plot from the top of FIG. 3 is a plot of engine state versus time. The vertical axis represents engine state and the engine is activated (e.g., combusting air and fuel) when trace 314 is at a higher level near the vertical axis arrow. The engine is not activated when trace 314 is at a lower level near the horizontal axis. The horizontal axis represents time and time increases from the right side of the plot to the left side of the plot. Trace 314 represents engine operating state.

The eighth plot from the top of FIG. 3 is a plot of automatic engine stop/start request state versus time. The vertical axis represents automatic engine stop/start request state and the automatic engine stop/start request is asserted when the automatic engine stop/start request state trace 316 is at a higher level near the vertical axis arrow. The automatic engine stop/start request is not asserted when trace 316 is at a lower level near the horizontal axis. The horizontal axis represents time and time increases from the right side of the plot to the left side of the plot. Trace 316 represents the automatic engine stop/start request state.

At time t0, the vehicle speed is at a higher level and the system induced inhibit of automatic engine stop is not asserted. The system induced inhibit of automatic engine stop reset speed is not shown since conditions for activating automatic engine stop/start are not present. The vehicle brakes are not applied and the driver demand torque is at a middle level. The SOC level is high and the engine is activated. Automatic engine stop/start is not presently requested.

Just before time t1, the vehicle driver (not shown) reduces the driver demand torque via releasing the accelerator pedal (not shown). At time t1, an automatic engine stop request is generated as is indicated by the automatic engine stop request being asserted. The engine stops shortly thereafter and the system induced inhibit of automatic engine stop reset speed is set to the vehicle speed at which the engine stopped. The driver demand torque is zero and the SOC is high. The vehicle brakes are applied at time t1, which initiates the automatic engine stop request. The system induced inhibit of the automatic engine stop/start is not asserted.

Between time t1 and time t2, vehicle speed decreases as the vehicle brakes remain in an applied state and the driver demand torque is zero. The system induced inhibit of the automatic engine stop/start is not asserted and the system induced inhibit of the automatic engine stop/start reset vehicle speed is reduced in accordance with vehicle speed as vehicle speed is reduced while the engine is automatically stopped. The battery SOC declines as vehicle systems (e.g., the vehicle climate control system) consume energy from the battery. The engine remains stopped (not rotating) and the automatic engine stop request remains asserted.

At time t2, SOC is reduced to a level below threshold 350, which causes the controller to issue a system induced inhibit of automatic engine stop/start. Trace 304 transitions to a high level to indicate that the system induced inhibit of automatic engine stop/start is activated. The engine is started as is indicated by the change in the engine state to a higher level. The system induced inhibit of automatic engine stop/start reset speed is at the level of vehicle speed when the system induced inhibit of automatic engine stop/start was activated. The vehicle brakes are applied and the driver demand torque is zero. The automatic engine stop request remains asserted, but the engine is not stopped because of the system induced inhibit of automatic engine stop/start is asserted.

At time t3, the driver demand torque is increased via the driver (not shown) and the vehicle begins to accelerate. The system induced inhibit of automatic engine stop/start remains asserted and the system induced inhibit of automatic engine stop/start reset speed remains at its previous value. The driver also releases the vehicle brake and the SOC is increasing as the engine charges the vehicle battery. The engine remains activated and the automatic engine stop/start request is withdrawn in response to the increase in driver demand torque.

At time t4, the actual vehicle speed exceeds the system induced inhibit of automatic engine stop/start reset speed plus an offset vehicle speed so that the system induced inhibit of automatic engine stop/start is withdrawn or no longer asserted. The system induced inhibit of automatic engine stop/start reset speed is not indicated because the automatic engine stop/start conditions are not present. The vehicle brakes are not applied and the driver demand torque increases in response to accelerator pedal position (not shown). The SOC continues to increase and the engine remains activated. The automatic engine stop/start request is not asserted.

Between time t4 and time t5, the vehicle accelerates and the engine remains activated. The vehicle brakes are not applied and the SOC increases. The system induced inhibit of automatic engine stop/start is not asserted and the system induced inhibit of automatic engine stop/start reset speed is not indicated. The driver demand torque is at a middle level and the automatic engine stop/start request is not asserted.

At time t5, the vehicle driver (not shown) reduces the driver demand torque via releasing the accelerator pedal (not shown) and applies the vehicle brakes. Shortly thereafter, an automatic engine stop request is generated as is indicated by the automatic engine stop request being asserted. The engine stops shortly thereafter and the system induced inhibit of automatic engine stop/start reset speed is set to the vehicle speed at which the engine stopped. The system induced inhibit of the automatic engine stop/start is not asserted.

Between time t5 and time t6, vehicle speed decreases as the vehicle brakes remain in an applied state and the driver demand torque is zero. The system induced inhibit of the automatic engine stop/start is not asserted and the system induced inhibit of the automatic engine stop/start reset vehicle speed is reduced in accordance with vehicle speed as vehicle speed is reduced while the engine is automatically stopped. The battery SOC declines as vehicle systems consume energy from the battery. The engine remains stopped (not rotating) and the automatic engine stop request remains asserted.

At time t6, SOC is reduced to a level below threshold 350, which causes the controller to issue a system induced inhibit of automatic engine stop/start. Trace 304 transitions to a high level to indicate that the system induced inhibit of automatic engine stop/start is activated. The engine is started as is indicated by the change in the engine state to a higher level. The system induced inhibit of automatic engine stop/start reset speed is at the level of vehicle speed when the system induced inhibit of automatic engine stop/start was activated. The vehicle brakes are applied and the driver demand torque is zero. The automatic engine stop request remains asserted, but the engine is not stopped because of the system induced inhibit of automatic engine stop/start being asserted. Shortly after time t6, the driver releases the vehicle brakes.

At time t7, the driver increases the driver demand torque and the automatic engine stop/start request is withdrawn in response to the increased driver demand torque. The engine is operating and the system induced inhibit of automatic engine stop/start remains asserted since actual vehicle speed is less than the system induced inhibit of automatic engine stop/start reset vehicle speed. The system induced inhibit of automatic engine stop/start reset vehicle speed remains at its previous level and the vehicle brakes are not applied. The SOC increases and the automatic engine stop/start request is not asserted.

At time t8, the actual vehicle exceeds the system induced inhibit of automatic engine stop/start reset speed plus an offset vehicle speed so the system induced inhibit of automatic engine stop/start is cleared or withdrawn. The vehicle brakes are not applied and the driver demand torque continues to increase. The SOC increases and the automatic engine stop/start request is not asserted.

In this way, a system induced inhibit of automatic engine stop/start may be asserted and withdrawn responsive to vehicle conditions including actual vehicle speed, SOC, brake state, and driver demand torque. The system induced inhibit of automatic engine stop/start may also be withdrawn responsive to a system induced inhibit of automatic engine stop/start reset vehicle speed so that the system induced inhibit of automatic engine stop/start may be withdrawn at different threshold levels of vehicle speed.

Referring now to FIG. 4, a method for operating an engine is disclosed. The method of FIG. 4 may be incorporated into the system of FIGS. 1-2B as executable instructions stored in non-transitory memory. Additionally, portions of the method of FIG. 4 may be acts performed via the controller 12 shown in FIGS. 1, 2A, and 2B to transform a state of a device or actuator in the real world.

At 402, method 400 combusts air and fuel within an engine while a transmission that is coupled to the engine is engaged in a gear (e.g., 2^{nd} gear). Fuel and spark are supplied to the engine responsive to engine operating conditions including but not limited to engine speed, engine load, ambient temperature, engine temperature, and driver demand torque. The driver demand torque may be provided via an accelerator pedal position that is input to the engine controller. Method 400 proceeds to 404.

At 404, method 400 judges is actual vehicle speed (Vspd) is less than a threshold upper limit (e.g., maximum vehicle speed for automatic engine stop/start) vehicle speed (Vspd_thr_max). In one example, method 400 compares an actual vehicle speed determined from a wheel speed sensor or a transmission speed sensor to the threshold level. If method 400 judges that actual vehicle speed is less than a threshold upper limit vehicle speed, then the answer is yes and method 400 proceeds to 406. Otherwise, the answer is no and method 400 returns to 402.

At 406, method 400 judges if vehicle brakes are applied if the vehicle in which method 400 operates includes an automatic transmission. If the vehicle in which method 400 operates includes a manual transmission, method 400 judges if the transmission clutch and the vehicle brakes are applied. If method 400 judges that the vehicle brakes are applied for an automatic transmission vehicle, the answer is yes and method 400 proceeds to 408. If method 400 judges that the vehicle brakes and manual transmission clutch are applied for a manual transmission vehicle, the answer is yes and method 400 proceeds to 408. Otherwise, the answer is no and method 400 returns to 402.

At 408, method 400 judges if the actual vehicle speed is less than a threshold adaptive vehicle speed (Vspd_thr_adpt). The value of Vspd_thr_adpt may be less than the value of Vspd_thr_max and greater than the value of the system induced inhibit of automatic engine stop/start reset speed (Vspd_rst) plus an offset vehicle speed (Vspd_off). If method 400 judges that the actual vehicle speed is less than the threshold adaptive vehicle speed, then the answer is yes and method 400 proceeds to 410. Otherwise, the answer is no and method 400 returns to 402.

At 410, method 400 automatically stops the engine when automatic engine stop conditions are present. For example, method 400 may stop the engine when driver demand torque is less than a threshold torque. In other examples, other and/or additional vehicle operating conditions may be the basis for automatically stopping the engine. For example, the engine may be automatically stopped when driver demand torque is less than a threshold while battery state of charge is greater than a threshold. Further, the engine may be automatically stopped if the engine has not been automatically stopped within a threshold amount of time (e.g., 25 seconds). The engine is stopped from rotating via ceasing fuel flow and spark to the engine. While the engine is automatically stopped, method 400 also stores and continuously updates a lowest speed of the vehicle in which the engine resides. This speed becomes the system induced inhibit of automatic engine stop/start reset speed (Vspd_rst). If the engine is restarted, the value of the system induced inhibit of automatic engine stop/start reset speed is maintained until the system induced inhibit of automatic engine stop/start speed is cleared or not asserted. Method 400 proceeds to 412.

At 412, method 400 judges if a system induced inhibit of automatic engine stop/start is present. If method 400 judges that a system induced inhibit of automatic engine stop/start is present, method 400 proceeds to 414. Otherwise, method 400 returns to 410.

A system induced inhibit of automatic engine stop/start may be generated in response to a variety of vehicle operating conditions including but not limited to low state of battery charge, low battery voltage, a climate control request to improve passenger cabin heating or cooling, battery current greater than a threshold current, low vacuum level in a vacuum reservoir, vehicle stopped on a grade that is greater than a threshold, steering angle greater than a threshold, and rate of steering angle change greater than a threshold. Controller 12 may initiate the system induced inhibit of automatic engine stop/start responsive to vehicle operating conditions.

At 414, method 400 automatically starts the engine. The engine may be automatically started via supplying spark and fuel to the engine while rotating the engine via a starter or an integrated starter/generator. Method 400 proceeds to 416.

At 416, method 400 asserts that the system induced inhibit of automatic engine stop/start request is present. The system induced inhibit of automatic engine stop/start request causes the engine to automatically start at 414. The system induced inhibit of automatic engine stop/start request prevents the engine from being automatically stopped even if the automatic engine stop is requested in response to a low driver demand torque or other vehicle operating conditions that would otherwise cause the engine to automatically stop. Method 400 proceeds to 418.

At 418, method 400 judges if the present vehicle speed is greater than the system induced inhibit of automatic engine stop/start reset speed (Vspd_rst) plus an offset vehicle speed (Vspd_off). If so, the answer is yes and method 400 proceeds to 450. Otherwise, the answer is no and method 400 proceeds to 420.

At 450, method 400 clears the system induced inhibit of automatic engine stop/start. By clearing the system induced inhibit of automatic engine stop/start, the system induced inhibit of automatic engine stop/start is no longer asserted so that the engine may be once again automatically stopped and started according to vehicle conditions. If an automatic engine stop is requested after the system induced inhibit of automatic engine stop/start is cleared, the value of Vspd_rst may also be cleared or set to a predetermined high value. Method 400 returns to 408.

At 420, method 400 maintains the system induced inhibit of automatic engine stop/start in an activated state so that the engine may not be automatically stopped and started in response to an automatic engine stop request. Method 400 returns to 406.

In this way, an engine of a vehicle may be automatically stopped and restarted if a system induced inhibit of automatic engine stop/start is asserted. The system induced inhibit of automatic engine stop/start may remain activated until actual present vehicle speed exceeds a system induced inhibit of automatic engine stop/start reset vehicle speed plus an offset vehicle speed, then it may be deactivated or not asserted so that the engine may be automatically stopped and started once again responsive to vehicle operating conditions.

Thus, method 400 provides for an engine operating method, comprising: automatically stopping an engine; automatically starting the engine after a most recent automatic stopping of the engine in response to a vehicle system induced automatic engine stop inhibit request being asserted; and adjusting a vehicle speed at which the vehicle system induced automatic engine stop inhibit request is cancelled responsive to a lowest vehicle speed achieved while the engine was automatically stopped. The method further comprises adjusting the vehicle speed at which the vehicle system induced automatic engine stop inhibit request is cancelled responsive to a predetermined offset vehicle speed. The method includes where the vehicle system induced automatic engine stop inhibit request is asserted to automatically start the engine. The method includes where the vehicle system induced automatic engine stop inhibit request is asserted in response to a battery state of charge. The method includes where the vehicle system induced automatic engine stop inhibit is asserted in response to a low vacuum level in a vacuum reservoir.

In some examples, the method includes where the vehicle system induced automatic engine stop inhibit is asserted in response to a vehicle passenger cabin climate control device request. The method includes where the vehicle system induced automatic engine stop inhibit is asserted in response to a steering angle that is greater than a threshold. The method further comprises cancelling the vehicle system induced automatic engine stop inhibit request in response to a speed of a vehicle exceeding the lowest vehicle speed achieved while the engine was automatically stopped plus an offset speed.

The method of FIG. 4 also provides for an engine operating method, comprising: automatically stopping an engine a first time; restarting the engine at a first vehicle speed after stopping the engine the first time in response to a vehicle system induced automatic engine stop inhibit request, and cancelling the vehicle system induced automatic engine stop inhibit request when a vehicle reaches first vehicle speed plus an offset speed; automatically stopping the engine a second time; and restarting the engine at a second vehicle speed after stopping the engine the second time in response to a vehicle system induced automatic engine stop inhibit request, and cancelling the vehicle system induced automatic engine stop inhibit request when a vehicle reaches second vehicle speed plus an offset speed. The method of claim 9, where cancelling the vehicle system induced automatic engine stop inhibit request permits the engine to be automatically stopped. The method includes where the vehicle system induced automatic engine stop inhibit request prevents the engine from being automatically stopped. The method includes where the engine is coupled to an automatic transmission. The method includes where the engine is coupled to a manual transmission. The method includes where the first speed is different from the second speed, and where the first speed is a lowest vehicle speed achieved while the engine was automatically stopped the first time.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, I3, I4, I5, V6, V8, V10, and V12 engines operating in natural gas, gasoline, diesel, or alternative fuel configurations could use the present description to advantage.

1. An engine operating method, comprising:
automatically stopping an engine;
automatically starting the engine after automatically stopping the engine in response to a vehicle system induced automatic engine stop inhibit request; and
adjusting a vehicle speed at which the vehicle system induced automatic engine stop inhibit request is cancelled responsive to a lowest vehicle speed achieved while the engine was automatically stopped.

2. The method of claim 1, further comprising adjusting the vehicle speed at which the vehicle system induced automatic engine stop inhibit request is cancelled responsive to a predetermined offset vehicle speed.

3. The method of claim 1, where the vehicle system induced automatic engine stop inhibit request is asserted to automatically start the engine.

4. The method of claim 3, where the vehicle system induced automatic engine stop inhibit is asserted in response to a battery state of charge.

5. The method of claim 3, where the vehicle system induced automatic engine stop inhibit is asserted in response to a low vacuum level.

6. The method of claim 3, where the vehicle system induced automatic engine stop inhibit is asserted in response to a vehicle passenger cabin climate control device request.

7. The method of claim 3, where the vehicle system induced automatic engine stop inhibit is asserted in response to a steering angle that is greater than a threshold.

8. The method of claim 1, further comprising cancelling the vehicle system induced automatic engine stop inhibit request in response to a speed of a vehicle exceeding the lowest vehicle speed achieved while the engine was automatically stopped plus an offset speed.

9. An engine operating method, comprising:
automatically stopping an engine a first time;
restarting the engine at a first vehicle speed after stopping the engine the first time in response to a vehicle system induced automatic engine stop inhibit request, and cancelling the vehicle system induced automatic engine stop inhibit request when a vehicle reaches first vehicle speed plus an offset speed;
automatically stopping the engine a second time; and
restarting the engine at a second vehicle speed after stopping the engine the second time in response to a vehicle system induced automatic engine stop inhibit request, and cancelling the vehicle system induced automatic engine stop inhibit request when a vehicle reaches second vehicle speed plus an offset speed.

10. The method of claim 9, where cancelling the vehicle system induced automatic engine stop inhibit request permits the engine to be automatically stopped.

11. The method of claim 9, where the vehicle system induced automatic engine stop inhibit request prevents the engine from being automatically stopped.

12. The method of claim 9, where the engine is coupled to an automatic transmission.

13. The method of claim 9, where the engine is coupled to a manual transmission.

14. The method of claim 9, where the first speed is different from the second speed, and where the first speed is a lowest vehicle speed achieved while the engine was automatically stopped the first time.

15. A system, comprising:
an engine; and
a controller including executable instructions stored in non-transitory memory to automatically stop the engine, monitor vehicle speed while the engine is automatically stopped, automatically restart the engine in response to a vehicle system induced automatic engine stop inhibit request, and clear the vehicle system induced automatic engine stop inhibit request in response to a lowest vehicle speed achieved while the engine was automatically stopped.

16. The system of claim 15, where the lowest vehicle speed is a speed of a vehicle that the engine propels.

17. The system of claim 15, further comprising additional instructions to assert the vehicle system induced automatic engine stop inhibit request in response to a battery state of charge.

18. The system of claim 15, further comprising additional instructions to assert the vehicle system induced automatic engine stop inhibit request in response to a vacuum level.

19. The system of claim 15, further comprising additional instructions to assert the vehicle system induced automatic engine stop inhibit request in response to a vehicle climate control system.

20. The system of claim 15, where clearing the vehicle system induced automatic engine stop inhibit request allows the engine to automatically stop.
